(19) United States
(12) Patent Application Publication
(10) Pub. No.: US 2004/0024076 A1
(43) Pub. Date: Feb. 5, 2004

(54) Polymerization of various silicic acids on biological templates

(76) Inventor: Clyde Edward Davis, Bend, OR (US)

Correspondence Address: Clyde E. Davis, 65535 - 93rd Street, Bend, OR, 97701, US

(21) Appl. No.: 10/413,988

(22) Filed: Apr. 15, 2003

Related U.S. Application Data
(60) Provisional application No. 60/374,047, filed on Apr. 20, 2002.

(51) Int. Cl. C08H 1/00; C08G 77/00

(52) U.S. Cl. 521/154; 525/54.3; 525/54.31

(57) ABSTRACT

Methods are disclosed for using biopolymers as templates for the polymerization of monomeric silicic acids. A method is provided wherein a biological polymer is used as a template. An inorganic polymer backbone forms a shell encasing the biopolymer template. The organic portion may be removed to leave inorganic nanotubes or other micro- or nano-scale structures which are the approximate size and shape of the template. The surface macrostructure of the biological template is duplicated in a silica shell—even molecular level imprinting is possible. The resulting silica structures have many uses, especially where micro- or nano-scale morphology should be controlled. Catalysts, semiconductors or metals may be deposited on the inside surface of the inorganic shell support. In another example, micro- or nano-particles that mimic the size and shape of the biopolymer template may be synthesized.

### CROSS-REFERENCE TO RELATED APPLICATIONS

This application claims the benefit of the earlier filing date of U.S. provisional patent application No. 60/374,047, filed on Apr. 20, 2002, the entire contents of which are incorporated herein by reference.

### FIELD

The present disclosure relates to the chemical synthesis of molds duplicating the macro-scale and molecular-level surface structure of a template material, including the synthesis of microporous or nanoporous compounds comprising silicon.

### BACKGROUND

The present methods and compositions relate to the duplication of a biological material with silica or a polysilicic acid. A mold of the biological material is made with the silica polymer. The principle is based upon the known hydrolytic reactions of silicon tetrachloride (and other tetrahalosilanes) and their rapid reaction with polar groups which are present on biopolymers. The hydrolysis of silicon tetrachloride and the mechanism for polymerization to polysilicic acid have been reviewed. See, e.g., Gmelin Handbuch der Anorganischen Chemie, “Silicium,” 15 (Teil b), Verlag Chemie, Weinheim,; pp. 685-686 (1959); and Bailer, J. C. et al., Comprehensive Inorganic Chemistry, Pergamon Press, Oxford, pp. 1425-1430 (1973).

The synthetic methods reported in the literature have focused on the use of the sol-gel method of synthesis to produce ordered structures of silica and other inorganic materials. With these concepts, alkoxysilanes, such as tetraethyl orthosilicate (TEOS), undergo hydrolysis in the presence of ionic or nonionic surfactants to yield micelle template structures. A wide range of surfactants and polymers have been used as templates for the polymerization of silica. Variation of the self-assembling surfactants results in different silica structures. Various metals and metal oxides have been inserted into mesoporous structures synthesized by the sol-gel method. In other sol-gel research, bacteria were used as a template in an attempt to control the pore size. See Davis, S. et al., Nature, 385, 420 (1997).

The known materials made by sol gel and sodium silicate deposition techniques suffer from relative mechanical instability leading to collapse of the structure and imperfect replication of the surface morphology of the template.

Notwithstanding the substantial ongoing research into nano-structures, there remains a need for an efficient and precise means to create porous structures from templates and to imprint the surface structure of a template into a mold. It also should be apparent to one of skill in the art that there exists a need for an efficient and broadly applicable technique for synthesizing inorganic duplicates or analogs of biological structures that would be useful as catalysts, enzyme molds, micro- or nanoscale structures and the like. The novel approach disclosed herein satisfies these and other needs through an elegantly efficient synthetic approach without certain limitations inherent to the sol gel method or other methods of producing various silica hybrid structures that self-assemble into crystalline mesoporous silicate chains.

### BRIEF SUMMARY OF THE DISCLOSURE

The structures of biological substances are well known. However, the utilization of biopolymers or biological structures as templates for forming inorganic polymers has attracted very little attention in the literature. The duplication of such biological substances with an inorganic polymer offers the possibility of forming unlimited morphological structures with different pore sizes and surface characteristics. Both nanoporous and mesoporous structures are disclosed. Novel synthetic techniques are disclosed herein in which a reaction of the biopolymer or biological structure is carried out with a silicon halide, preferably silicon tetrachloride (tetrachlorosilane), to form an inorganic mold or shell of the biopolymer or biological structure, which serves as a template on which the mold or shell forms to substantially encase the original biopolymer or biological structure. This unique method is somewhat akin to fossilization processes in nature. The superior duplication of the details of the template structure is thought to involve the chemical reaction of the silicon halide with polar functional groups on the template. Without limiting the scope of the disclosure and the appended claims, the methods disclosed herein may use any biopolymer, including synthetic equivalents or analogs, as a template.

### BRIEF DESCRIPTION OF THE FIGURES

FIG. 1 is a typical secondary electron image of the resultant silica fibers when cotton is used as the templating substrate.

FIG. 2 is a secondary electron image of the resulting hollow silica fibers when cotton fibers are used as the template and the cellulose is removed by pyrolysis. The parallel ridges and grooves on inner and outer surfaces are duplicated from the surface of cotton.

FIG. 3 is a secondary electron image of an untreated cotton fiber.

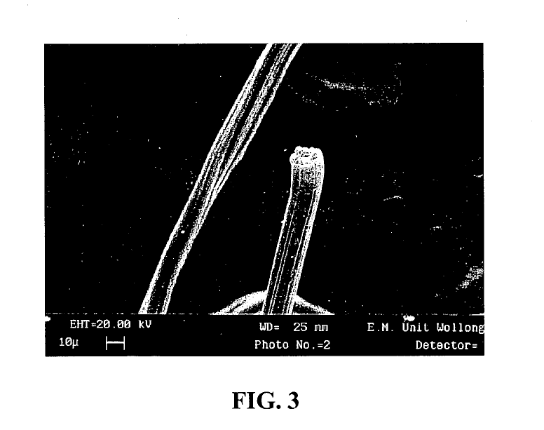

FIG. 4 is a secondary electron image of hollow tubes comprising polysilicic acid which remain after the cotton is dissolved in concentrated sulfuric acid.

FIG. 5 is a secondary electron image of silica. Wood was used as the template followed by pyrolysis to remove the cellulose. The cellular structure appears to be perfectly preserved in silica. Magnification was 4000×.

FIG. 6 is a secondary electron image of silica fiber. Silk was used as the template and then removed by pyrolysis. The pore size is approximately 18 μm.

FIG. 7 is a secondary electron image of a hollow silica fiber. Wool was used as the template, which was removed by pyrolysis.

FIG. 8 is a secondary electron image of untreated wool fiber. A comparison of FIG. 7 with FIG. 8 indicates that the surface pattern of the wool fiber has been duplicated on both the outside and inside surface of the silica tubes. The pore size of the hollow silica tubes is approximately 60 μm.

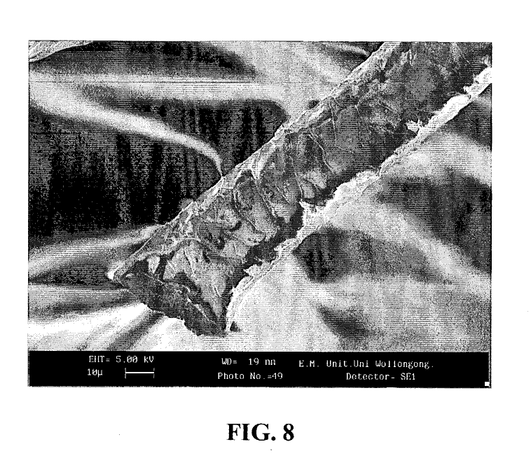

FIG. 9 is a secondary electron image of the silica tubes formed when metallic silver was first deposited on the cotton followed by reaction with SiCl₄ and then pyrolysis to remove the cotton template.

FIG. 10 is a secondary electron image of silica fibers with TiO₂. The cotton was first treated with a Tyzor LA, followed by reaction with SiCl₄ and then pyrolysis.

FIG. 11 is a secondary electron image of a hollow silica tube formed when cotton was first treated with hexachloroplatinic acid (which yields metallic platinum upon thermal decomposition).

FIG. 12 is an Atomic Force Microscope (AFM) image of the three-dimensional surface morphology of the inside of a silica fiber that contains platinum.

FIG. 13 is a section analysis of the inside surface of the silica fiber with platinum indicating that the height of the deposit ridges is about 10 nm.

FIG. 14 is an AFM image of cotton fiber.

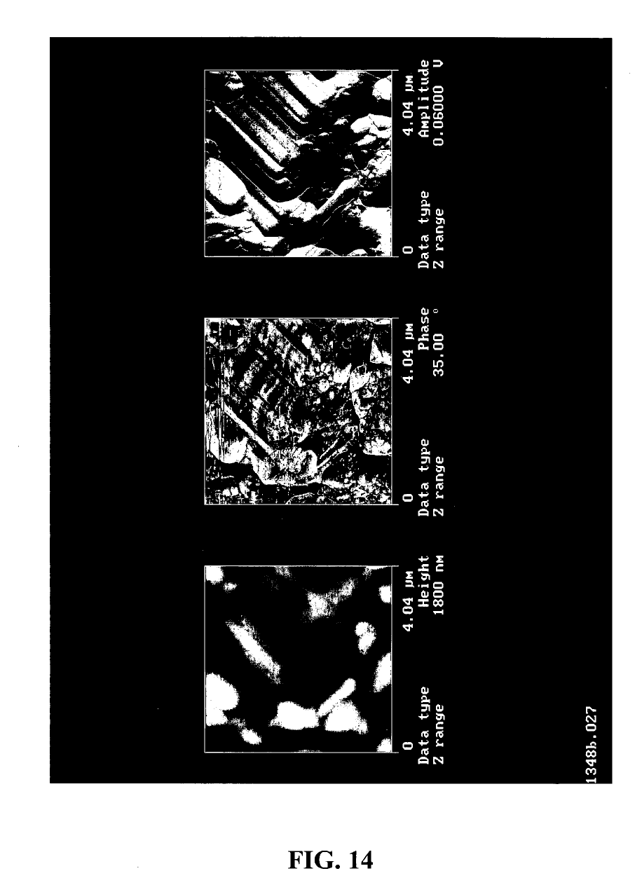

FIG. 15 is an AFM image of a silica imprint of cotton. The EDS analysis confirms that no detectable amount of carbon remains.

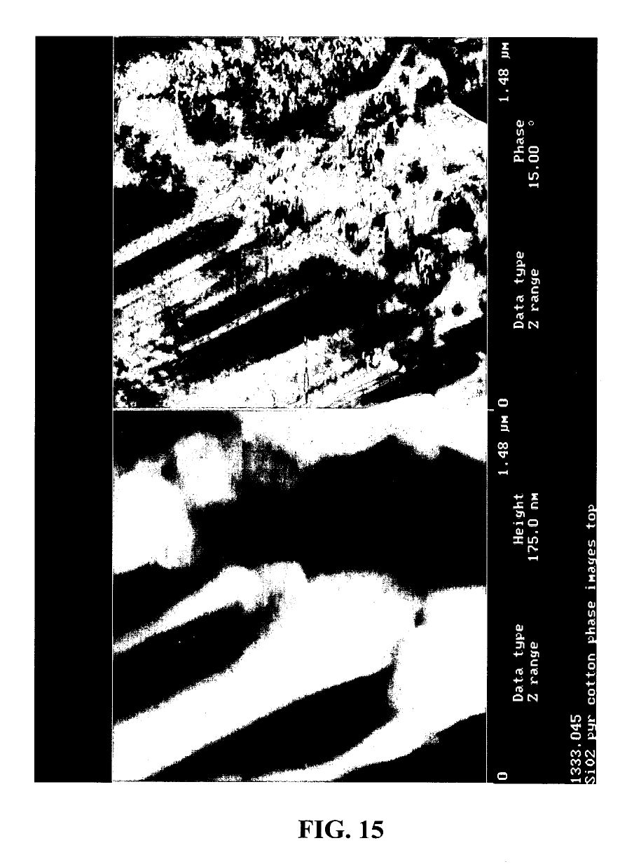

FIG. 16 is another AFM image of a silica imprint of cotton fiber.

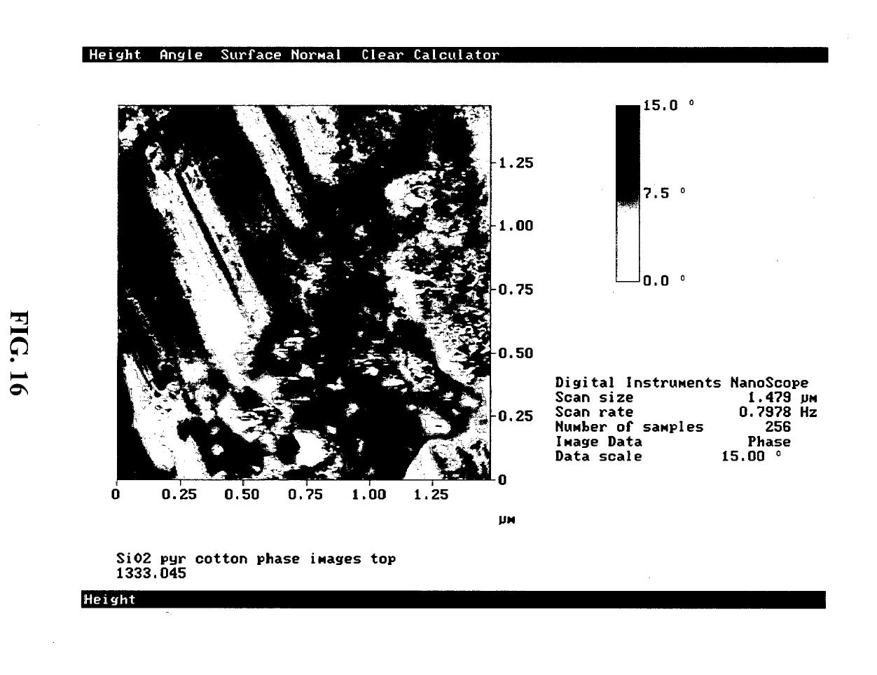

FIG. 17 is a secondary electron image of silica formed using fungi as a template.

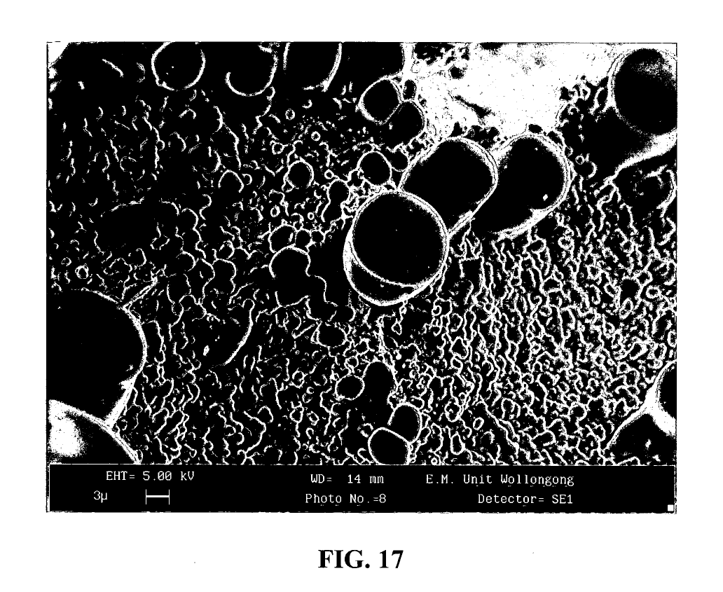

FIG. 18 is a secondary electron image of silica using starch as the template.

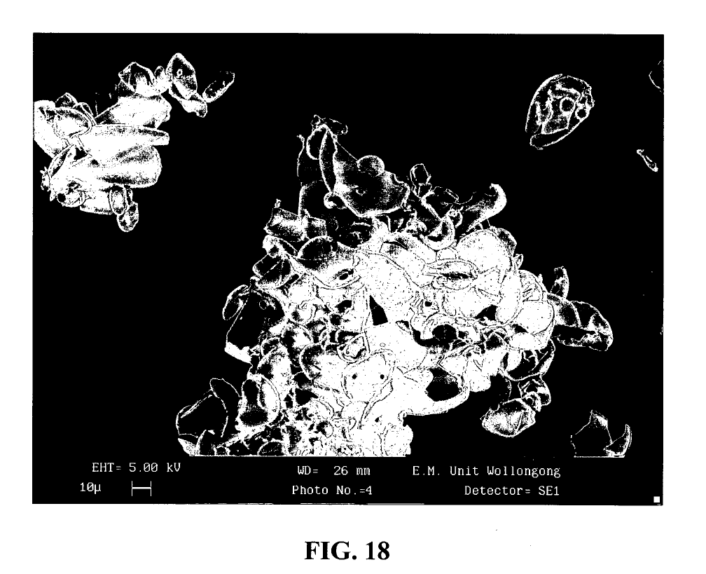

FIG. 19 is a secondary electron image of silica using DNA as the template.

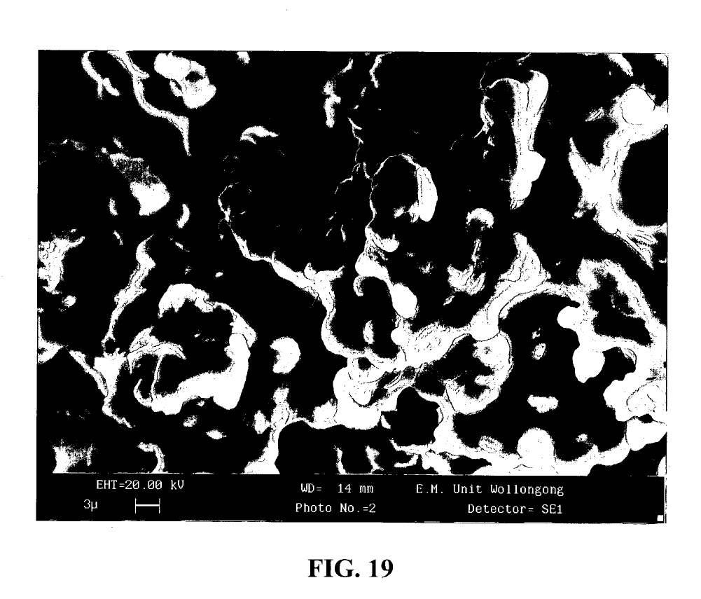

FIG. 20 is a secondary electron image of silica formed using starch as the template at higher magnification than FIG. 19.

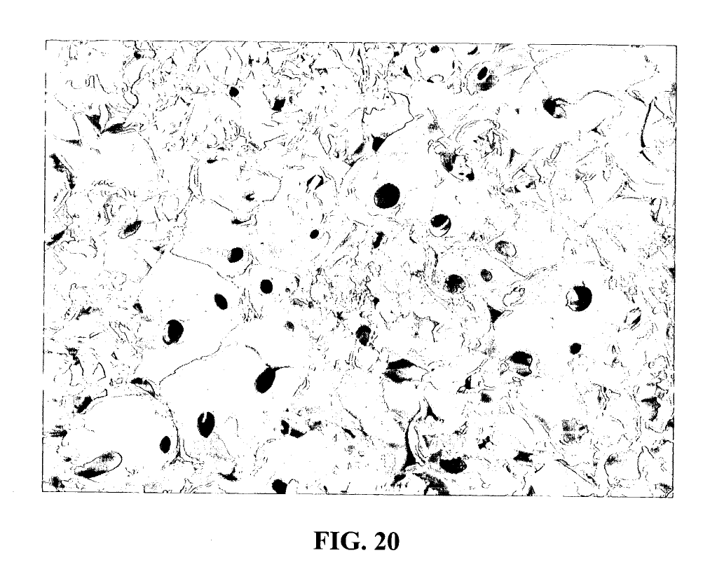

FIG. 21 is another secondary electron image of silica formed using starch as the template.

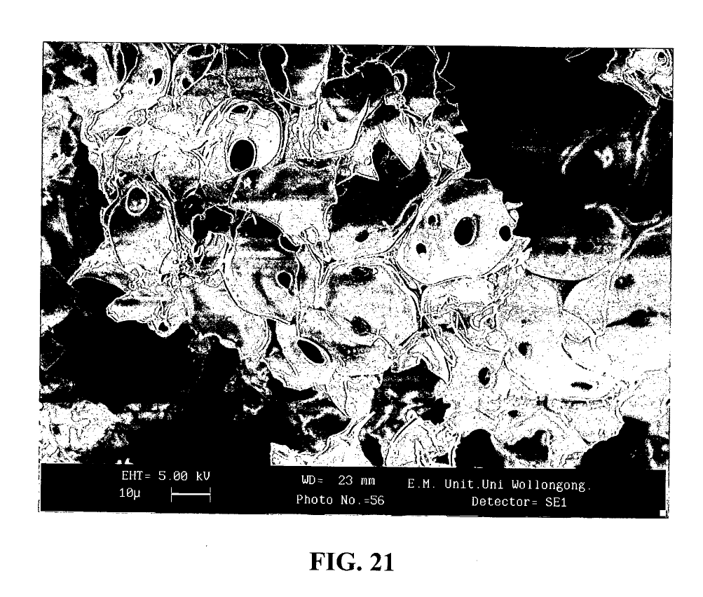

FIG. 22 is a secondary electron image of silica formed using cotton that was first treated with hexachloroplatinic acid as the template.

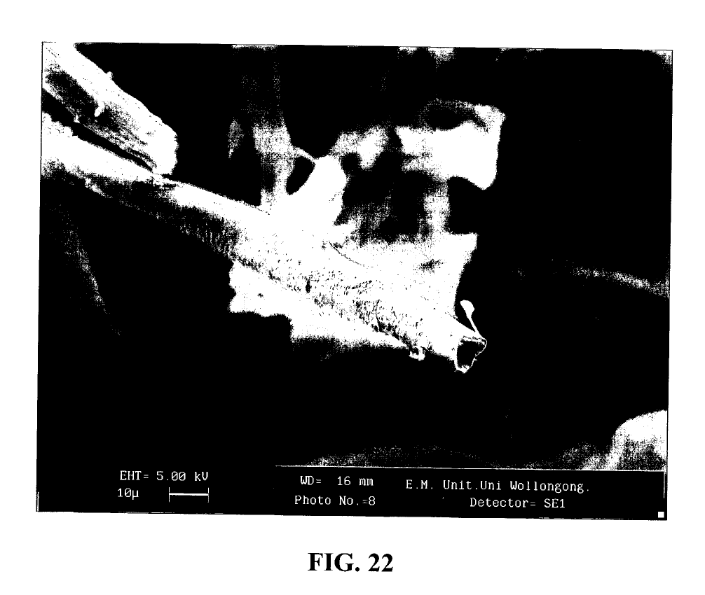

FIG. 23 is a secondary electron image of silica formed using cotton as the template. Dissolution of the template was by acid digestion rather than pyrolysis.

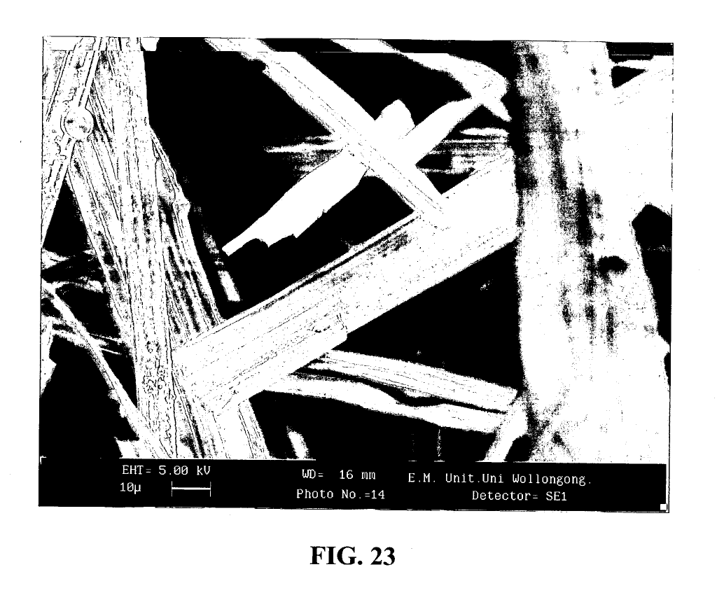

FIG. 24 is a secondary electron image of silica formed using wool as the template.

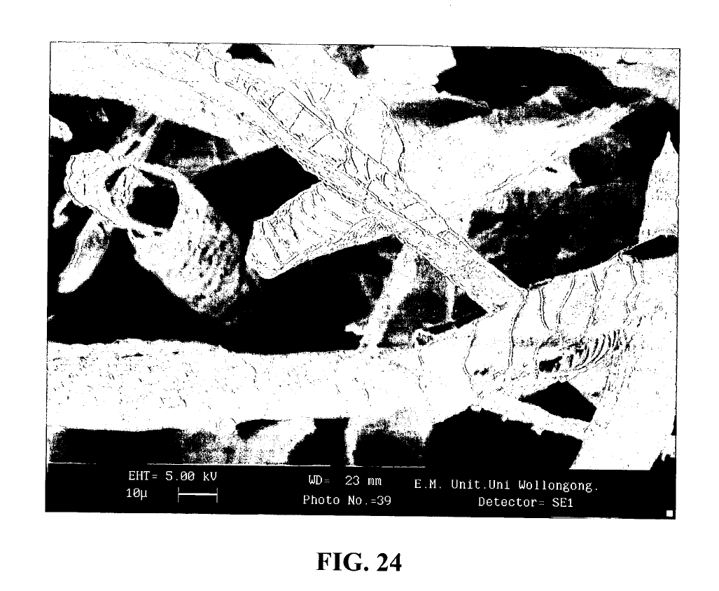

FIG. 25 is a secondary electron image of silica formed using silk as the template where dissolution was performed by acid digestion rather than pyrolysis.

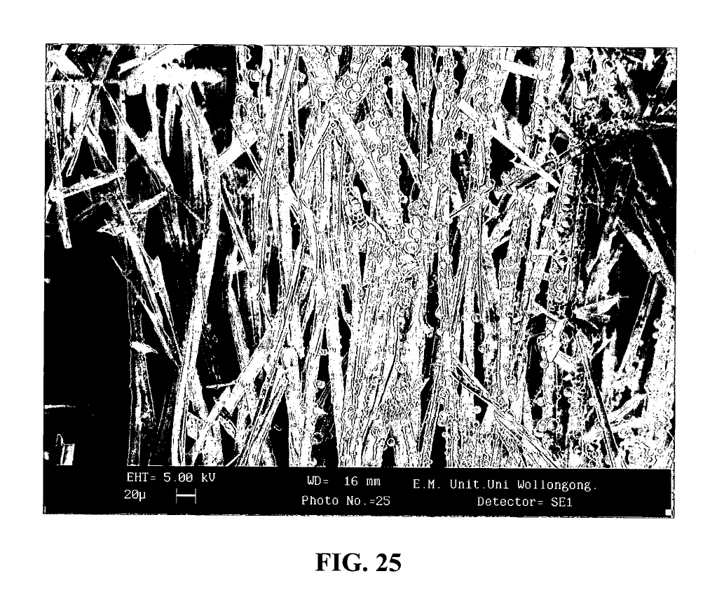

FIG. 26 is a secondary electron image of silica formed using silk as the template, which was removed by pyrolysis.

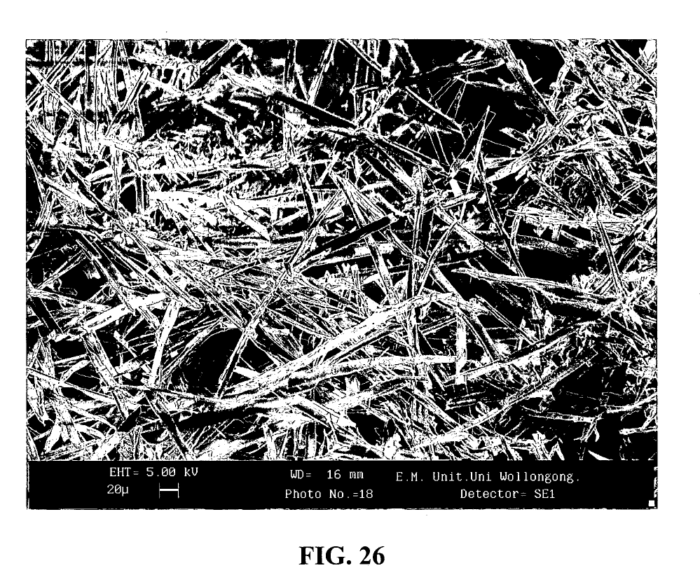

FIG. 27 is a secondary electron image of silica formed using cotton as the template where dissolution was by the tetraamminecopper (II) method rather than pyrolysis.

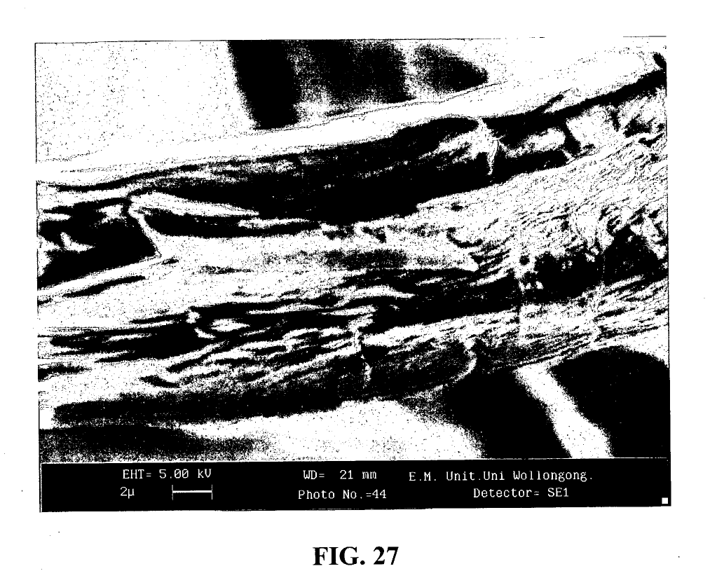

### DETAILED DESCRIPTION

The biological material used as a template was air-dried and used as received from the supplier. As used herein, the term biopolymer includes naturally occurring and modified polymeric materials or any synthetic polymer that is or may be used as a biopolymer analog to serve as a template (also sometimes referred to as the “biotemplate”) in the methods described herein. Thus, the term biopolymer includes but is not limited to cotton, silk, wool, cellulose, starch, DNA, RNA, proteins, cellular walls, micellular structures, wood, hair, fur, the interior and/or exterior surface of microbes (e.g., viruses, mold, fungi, spores, yeast, algae, protozoans, plankton), sugars, polysaccharides, cyclodextrins, carbohydrates, polypeptides, polyols, polyamines, polyacids, polyamides, polyimides and combinations or mixtures of the foregoing. A biopolymer also may comprise any of the aforementioned examples with other molecules or elements deposited on or chemically bonded to one or more of them.

Silicon tetrachloride may be used neat, with no solvent, or it may be dissolved in a solvent, especially a substantially nonpolar solvent such as carbon tetrachloride, n-hexane, n-pentane, cyclohexane, ethers or similar solvents and mixtures thereof. The best results were obtained using silicon tetrachloride; however, other silicon halides, such as silicon bromides and silicon iodides, can be used. The silicon halide can be selected from the group consisting of compounds of the formula SiX₁X₂X₃X₄, SiX₁X₂X₃R₁, SiX₁X₂R₁R₂, and combinations thereof where X₁, X₂, X₃ and X₄ are independently selected from the group consisting of chlorine, bromine, and iodine and R₁ and R₂ are independently selected from the group consisting of Lewis bases (e.g., hydroxyl, methoxy, ethoxy, phenol and alkoxy groups), alkyl or substituted alkyl groups (e.g., methyl, ethyl, isopropyl, butyl, trifluoroethyl, octyl, cyclohexyl, cyclopentyl), aryl or substituted aryl groups (e.g., phenyl, benzoyl, pentachlorophenyl), and heterocyclic groups (e.g., pyridyl). The R₁ and/or R₂ groups may then be present on the inorganic polymer backbone formed from the Examples disclosed herein.

### EXAMPLE 1

### A General Synthetic Approach

The general experimental method of encasing the biotemplate with silica is as follows. Herein, the material encasing the template may be referred to as simply the “mold” or “shell.” The air-dried biopolymer is placed in a polyethylene container with a cover. (The biopolymer may be air-dried, or dried by any other substantially nondestructive means.) In a well-ventilated hood, neat SiCl₄ is slowly injected into the container by means of a syringe until the material (i.e., the biopolymer or other analogous material used as the template) is saturated and absorbs no more SiCl₄. Over-saturation should be avoided because a large excess of SiCl₄ results in the formation of amorphous silica in the subsequent hydrolysis step. An excess of SiCl₄ can be minimized by using a solution of a non-polar solvent. If the stoichiometry is known for the template, approximately one mole of SiCl₄ is added per four moles of polar functional groups. The mixture of the SiCl₄ and biopolymer is allowed to react with atmospheric moisture, or added water, in a hood to form a reaction product. When the evolution of hydrogen chloride gas has ceased, additional water, if necessary, is added to quench any silicon halide or any reaction intermediates that may have not reacted with the biopolymer. The product is then air-dried. By an analogous procedure, other silicon halides may be used (accounting for any reduction in the molar equivalents of highly reactive Si—X bonds).

Rather than quenching the reaction product with water, functionalization of the final product can be accomplished by using an alternative Lewis base quenching reagent such as any organic alcohol or other hydroxy substituted compound. In other words, depending on the desired final product, final “hydrolysis” of the silicon halide may be performed by an alternative quenching reagent.

CAUTION: Silicon tetrachloride is a corrosive liquid. It reacts vigorously with water to produce hydrochloric acid and silicic acid fumes (silica smoke).

### EXAMPLE 2

### Removal of the Biotemplate

The template material (and/or any acid hydrolysis/decomposition by-products) can be removed from the mold or shell. Such removal includes, but is not limited to, pyrolysis or dissolution in an appropriate reagent or solvent.

### Pyrolysis Method

The air-dried product from Example 1 is placed in an open crucible and then heated in the hood to burn off the organic material. The material is heated with a high temperature burner or in an oven until all the carbon is gone and colorless fibers remain. The time required for this step varies depending on the template that is used. When cotton or silk is used as the template, colorless fibers remain after pyrolysis, which appear identical to the original template.

Energy Dispersive Spectroscopy (EDS) analysis showed that no detectable carbon was present in the hollow fibers after pyrolysis.

### Dissolution Method

Acid hydrolysis of a template is accomplished by adding concentrated sulfuric acid to the air-dried product resulting from the general synthetic approach disclosed above. After a day at room temperature, the acid-product mixture is slowly added to a large volume of water. It is then filtered and washed with reagent water until the solid is no longer strongly acidic. EDS analysis showed that no detectable carbon was present in the hollow fibers after dissolution.

Other reagents specific to cellulose, such as tetramminecopper (II) carbonate, can be used to dissolve a cotton template. The air-dried product from the general synthetic approach is added to a solution of tetramminecopper (II) cation and allowed to stand overnight at room temperature. The remaining fibers are then filtered and washed with reagent water until a colorless solid remains. EDS analysis showed that no detectable carbon or copper was present in the fibers.

### EXAMPLE 3

### Deposition of Various Materials on the Inside of Silica Fibers

The deposition of various materials on the silica fibers facilitates their use as catalysts, conductors, semiconductors, etc., depending on the deposition material. For example, deposition of platinum yielded silica with excellent catalytic properties for oxidation reactions.

### TiO₂

Titanium dioxide is deposited on the inside of silica fibers by first soaking the biopolymer, such as cotton, in a solution of a titanium complex, such as Tyzor LA (a lactic acid complex of titanium (IV) available from Dupont (Wilmington, Del. 19898). Other coordination compounds of titanium may also be used. The cotton is air-dried and then treated by the procedure detailed in the general synthetic approach. Pyrolysis of the product thermally decomposes the organic titanate to titanium dioxide and silica. EDS analysis confirms that titanium is present and no detectable carbon is present in the fibers.

### Ag

Metallic silver is deposited on the inside of fibers by first soaking the cotton in a solution of diamminesilver (I) nitrate. The cotton is then placed in a solution of glucose to reduce the ammonia complex. A black precipitate of metallic silver is deposited on the surface of the cotton. The cotton is then air-dried and treated as detailed in the general synthetic procedure. Silica fibers with metallic silver are produced. EDS analysis confirms that silver and silicon are present and no detectable carbon is present in the product fibers.

### Pt

Metallic platinum is deposited inside the silica by first soaking the cotton fibers in a solution of chloroplatinic acid or a similar platinum containing compound which can be thermally decomposed to metallic platinum. The fibers are air-dried then treated as in the general synthetic approach. Pyrolysis of the product thermally decomposes the chloroplatinic acid to metallic platinum and silica. Fibers with platinum are produced.

With the proper choice of reactants, various other materials can be deposited in or on any suitable template to be encased in the inorganic mold disclosed herein, including catalysts, metals, semiconductors, etc. The concentration and amount of any deposition material can be varied and controlled by deposition from a solution-phase. For example, an extremely small amount of a catalyst can be deposited by absorbing solutions of the catalyst (or a catalyst precursor) on the template. The disclosed techniques allow for the catalyst (or other deposition material) to be very finely divided, resulting in a high catalytic surface area and using only a small amount of catalyst.

### EXAMPLE 4

### Experimental Details of AFM, SEM and TEM

### AFM

The fibers were chopped with a sharp razor blade on a glass slide before being dispersed on to a fresh mica surface. The prepared AFM samples were then examined on a Digital Equipment Extended Multimode AFM (DEC, Hudson, Mass.). AFM images of the fibers were acquired in tapping mode using a SiN tip with 25 kHz frequency and 100 mV drive amplitude.

### SEM

The fibers were stuck to a double sided carbon tape with was attached to a metal stub. Scanning electron microscopy of the fibers was performed on a Leica Stereoscan 440 (Leica, England) scanning electron microscope, which is equipped with an Oxford Link ISIS 300 (Oxford, England) analytical system. Operating voltages between 5 kV and 20 kV were used. The low operating voltages revealed the fine details of the product fiber surface structure and minimized charging effects. High voltages were to achieve higher resolution. Scanning electron microscopy was also performed on a JEOL 2000 FX (JEOL, Tokyo, Japan) transmission electron microscope operated at 80 kV to maximize the resolution. Energy dispersive spectra of the fibers were obtained with a solid state Si(Li) detector with an ultra thin window capable of detecting up to the element boron.

### TEM

Transmission electron microscopy (TEM) samples were prepared by dispersing the fibers on whole carbon films. The samples were then examined on a JEOL 2000 FX (JEOL, Tokyo, Japan) transmission electron microscope at 80 kV.

### EXAMPLE 5

### Characterization of Certain Products

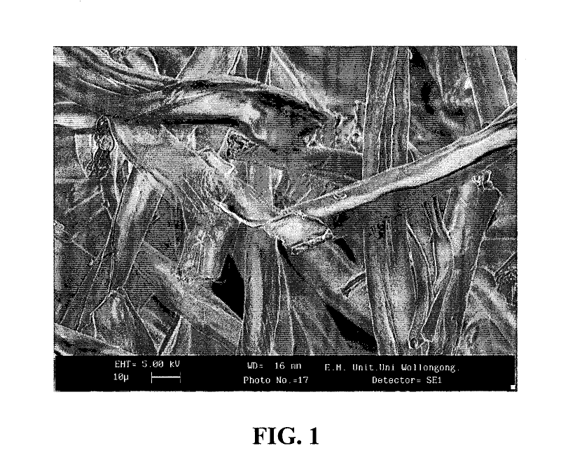

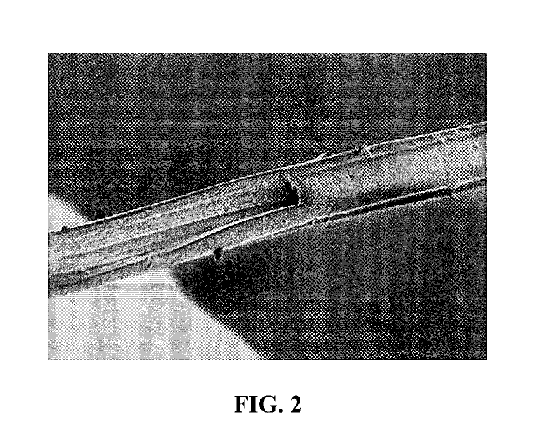

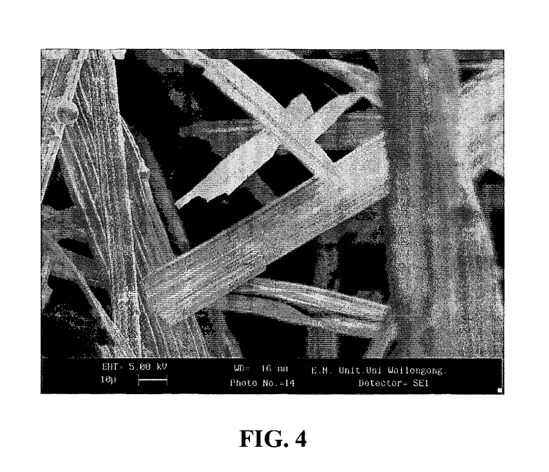

As described in the foregoing, the cotton or other biopolymer is typically first treated with neat silicon tetrachloride (SiCl₄). A large excess of SiCl₄ should be avoided since this can lead to the formation of amorphous silicic acid products that did not react with the biopolymer template. Following reaction with moisture in the air (or after another suitable hydrolysis), a polysilicic acid shell or mold encases the cotton fiber. (See FIG. 1.) Very little or no amorphous silica is produced. The cotton or other organic template may be decomposed by pyrolysis (calcination) until all the carbon is removed, leaving only a silica shell. (See FIG. 2.) Alternatively, the template can be removed by acid digestion, e.g., with sulfuric acid. (See FIG. 4.) In the case where cotton is used as the template, the tetraamminecopper (II) complex ion can also be used to dissolve the cellulose.

The advantages of using SiCl₄ are that the reaction occurs in high yield, is rapid and provides a nearly perfect replication of the template. Whether pyrolysis or dissolution is used, analysis by Energy Dispersive Spectroscopy (EDS) confirms that essentially all the carbon of the original template is removed. The pyrolysis method yields a product with a 1:2 ratio of silicon to oxygen.

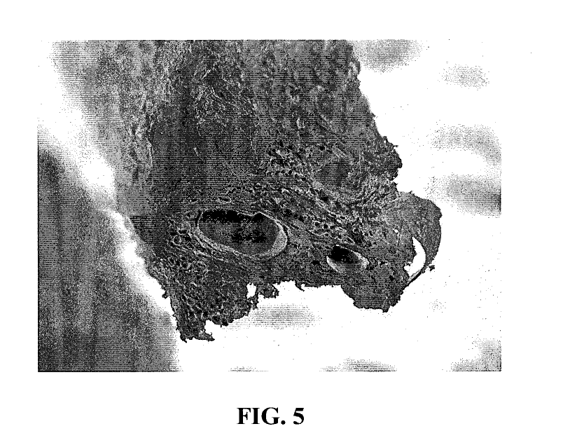

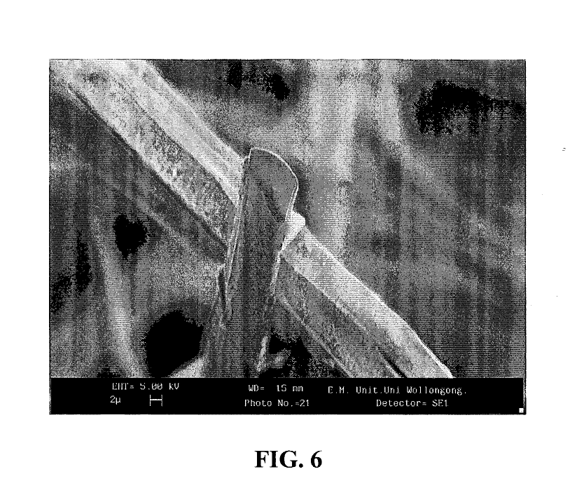

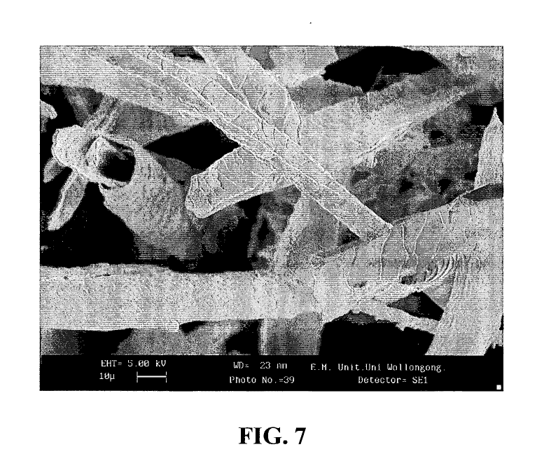

The morphology of the product is apparently determined and limited only by the choice of the template that is used. Detailed cell structure can be duplicated when wood is used as the template (FIG. 5). Silk and wool fibers have also been used as templates. (FIGS. 6, 7.)

Superior surface detail with little or no amorphous silica is achieved using SiCl₄. Alkoxysilanes, such as tetraethyl orthosilicate (TEOS), did not produce nearly as much detail; however, they do produce a certain product.

### EXAMPLE 6

### Deposition of Materials on Surfaces of a Silica Shell

It is possible for almost any material to be placed on the inside of the silica shell rather than solely on the outside surface of the silica by, for example, first treating the template with the material (or a compound, complex, mixture or solution thereof) before reaction with SiCl₄.

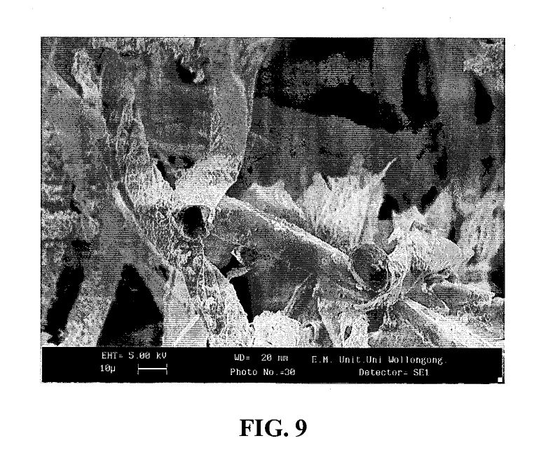

Silver may be deposited by soaking a biopolymer, such as cotton, in a solution of diaamminesilver (I) complex ion. The biopolymer, e.g., cotton, is then removed from the solution and placed into a second solution of glucose, which reduces the silver ion to a metallic silver precipitate on the surface of the biopolymer/cotton. In the case of cotton, the cotton with a silver surface is air-dried then reacted with silicon tetrachloride in the same manner as described in the preceding Examples. Yellow silica fibers remain after pyrolysis (FIG. 9).

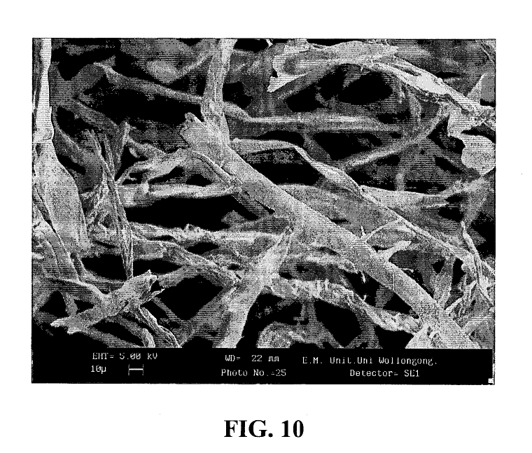

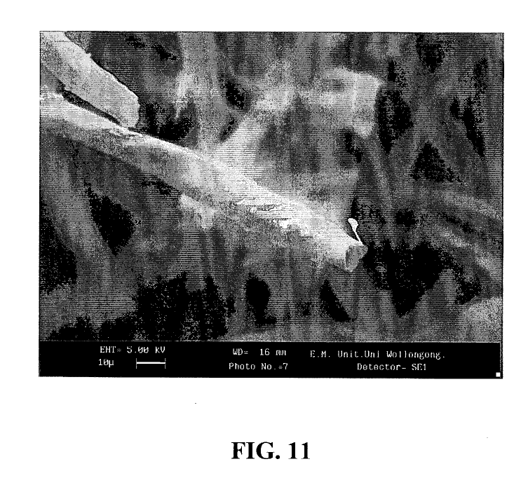

Various materials may also be deposited on the inside of the silica fiber if the template is first treated with a compound that can be thermally decomposed to yield the desired product. A procedure for depositing titanium dioxide is to soak cotton in an aqueous solution of Tyzor® (available from Dupont, Wilmington, Del. 19898), a water soluble lactic acid complex of titanium. The treated cotton is air-dried, reacted with SiCl₄ then pyrolyzed to leave titanium dioxide on the inner surface of the silica shell (FIG. 10). By an analogous procedure, metallic platinum can be deposited in the center of a silica fiber by the thermal decomposition of hexachloroplatinic acid (FIG. 11).

In this and all other Examples provided herein, removal of the organic template is not necessary. If a product containing an encapsulated template is desired, e.g., a biopolymer and/or any absorbed molecules encapsulated by a silica shell results after treatment with a silicon halide and hydrolysis.

### EXAMPLE 7

### Characterization of the Silica Tubes

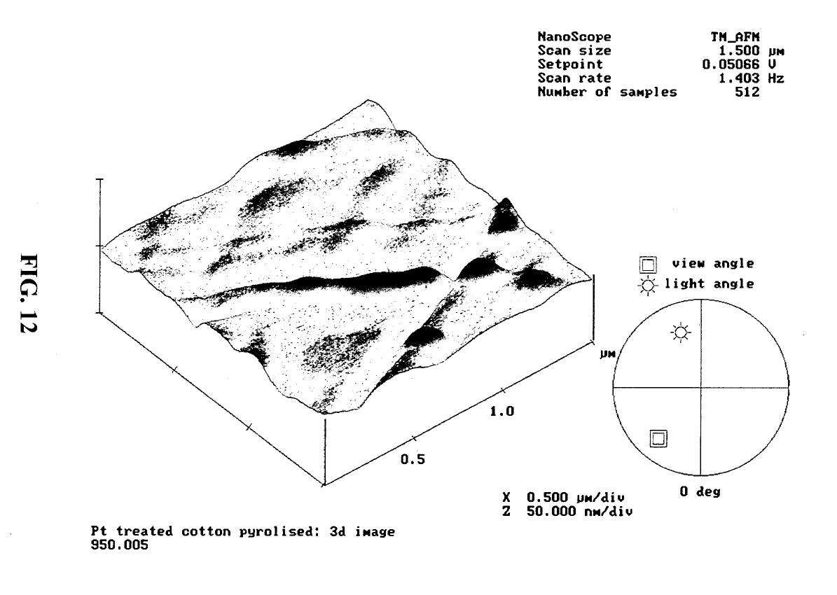

Atomic force microscopy (AFM) images of the inside of a silica fiber tube, wherein the template has been treated with platinum according to the foregoing procedures, shows that groves and ridges are present. Similar ridges are not observed on the outside surface of the same sample. Without being bound to any theory expressed herein, these ridges are thought to be the platinum catalyst. However the ridges are too small to be analyzed by SEM/EDS. (FIG. 12).

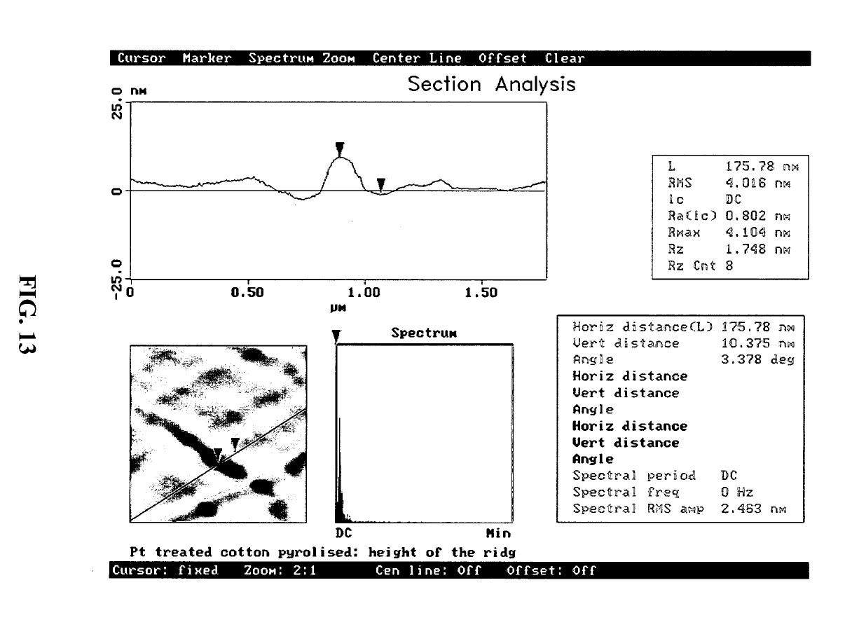

As seen in FIG. 13, the direction of the fiber is along the y-axis. The grooves and ridges are not parallel to the direction of the fiber. AFM analysis of a cross section of the inside of the fiber reveals that the height of the ridge is on the order of about 10 nm. (See FIG. 13.)

In the disclosed Examples provided herein, hollow fibers have been synthesized using cotton, wool and silk as templates. After the organic template is removed, the silica mold is a near-perfect duplication of the original template at the macroscopic level. When cotton is used as the template, dissolution of the cellulose gives a product that is best characterized as a polysilicic acid. The surface characteristics of the silica fibers formed using cotton as the template depends somewhat on the method by which the template is removed. Removal of the cotton template leaves hollow fibers with substantially uniform pore size and that are only slightly larger than the original template. Further analysis can confirm that molecular imprinting on the surface of the silica has occurred.

If the cotton is first treated with various catalysts, or any other material that can first be deposited on the template substrate, prior to the reaction with silicon tetrachloride, each of the resulting silica fibers appears to encase the metal catalyst to yield microtubes containing the catalytic material on the inside surface. Various catalysts of industrial interest have been incorporated into the silica structures. Based upon the synthetic method used, it is theorized that the catalysts are deposited on the inside of the silica fibers. AFM images of the platinized silica appear to confirm this.

It is also possible to use other biological materials such as wood, in which the cellular structure is duplicated.

### EXAMPLE 8

### Aerogels

A very low density material can be made by limiting the quantity of SiCl₄. A material produced by reacting the biotemplate with about one mole of SiCl₄ per four moles of polar functional groups in the biotemplate was found to have extremely low density after removal of the biotemplate. As used herein, a polar functional group generally means a Lewis base. It should also be noted that a convenient estimation of the number of polar functional groups in a particular biotemplate may be used, e.g., assume that there are four polar functional group reaction sites for each monomer of glucose when cellulose is used as a biotemplate.

A silica material substantially having the morphology of the templates described herein with a density on the order of that described in the literature for aerogels can be produced. Moreover, densities of from about 0.002 g/mL to about 0.10 g/mL can be expected depending upon reaction conditions. (Density in this context refers to the mass per macroscale volume of the silica material, i.e., the volume includes not only any pores in the material but also voids between any fibers or other macro-level structure of the material.)

A material produced according to the Examples provided herein having characteristics even approximating those of aerogels has numerous advantages over those made to date by sol gel and related methods. For example, the disclosed synthetic approach is simpler to carry out and more efficient. Such low density products may find use in many applications requiring low density, high insulating capacity and/or nonflammability.

### EXAMPLE 9

### Use of Mold to Form Polymeric Beads

Any of the molds or shells formed by the methods disclosed herein may, in turn, be used as templates for other reactions. For example, polymerization reactions can be carried out in the hollow inner spaces of the inorganic mold. By this procedure, a biopolymer template is, through several steps, substantially duplicated as a polymer.

Any mold formed according to the foregoing disclosure, such as a mold of fungi, starch or cotton fibers can be mixed with a monomer and a catalyst under vacuum. Simple filtration, optionally with a solvent wash, will separate the mold filled with monomers and catalyst from excess monomer, catalyst and/or solvent. Conditions are well known in the art for making various polymers from monomer/catalyst combinations. Example polymers include polystyrene, polyvinyl chloride, polyester, polypropylene, etc.

After filtration or other separation of the mold from excess reagents, the mold can simply be heated or subjected to any other well known conditions appropriate for forming the polymer of interest.

By this method, micro- or nano-scale polymeric material is formed substantially in the shape of the original biotemplate material.

The synthetic principles disclosed herein appear to have unlimited possibilities since the pore size and surface morphology of the resulting silica imprint appear to be limited only by the multitude of biological templates and their synthetic analogs available. Therefore, a person of ordinary skill in the art will recognize that the techniques herein described may be modified and applied to a plethora of templates and other substrates without deviating from the spirit and scope of the invention herein claimed. Thus, the foregoing description of various Examples with reference to the accompanying drawings should not be interpreted to define the scope of the present invention, which should instead be understood to be limited only by the scope of the following claims.

1. A method for preparing an inorganic shell of an organic material template, comprising:
providing an organic material template;
contacting the organic material template with a silicon halide; and
hydrolyzing the silicon halide.

2. The method of claim 1 wherein the organic material template is a biopolymer; the inorganic shell optionally contains R₁ or R₂ groups; and the silicon halide is selected from the group consisting of compounds of the formula SiX₁X₂X₃X₄, SiX₁X₂X₃R₁, SiX₁X₂R₁R₂, and combinations thereof where X₁, X₂, X₃ and X₄ are independently selected from the group consisting of chlorine, bromine, and iodine; and R₁ and R₂ are independently selected from the group consisting of Lewis bases, alkyl or substituted alkyl groups, aryl or substituted aryl groups, and heterocyclic groups.

3. The method of claim 1 wherein a metal, catalyst or semiconductor is deposited on the organic material template.

4. The method of claim 1 wherein the organic material template is a biopolymer.

5. The method of claim 4 wherein the biopolymer is selected from the group consisting of cotton, silk, wool, cellulose, starch, DNA, RNA, proteins, cellular walls, micellular structures, wood, hair, fur, the exterior surface of microbes, sugars, polysaccharides, cyclodextrins, carbohydrates, polypeptides, polyols, polyamines, polyacids, polyamides, polyimides, and combinations thereof.

6. The method of claim 4 wherein the silicon halide is SiCl₄.

7. The method of claim 5 wherein the inorganic shell is porous.

8. The method of claim 5 wherein the inorganic shell is mesoporous.

9. The method of claim 5 wherein the inorganic shell is microporous.

10. The method of claim 5 wherein the inorganic shell is nanoporous.

11. The method of claim 6 wherein the inorganic shell comprises a tube-shaped structure with an average interior pore diameter of less than about 15 μm.

12. The method of claim 1 wherein the organic material template is selected from the group consisting of cotton, silk, wool, cellulose, and combinations thereof.

13. The method of claim 1 wherein the organic material template is removed to leave a mold of the organic material template.

14. The method of claim 13 wherein the mold has a density approximately equal to the density of an aerogel.

15. The method of claim 13 wherein the mold has a density in the range of from about 0.002 g/mL to about 0.10 g/mL.

16. The composition of matter comprising a shell of a biological material, further comprising:
silicon compounds in which the microscale or nanoscale form, morphology, texture, or topography of the biological material has been substantially replicated.

17. The composition of matter according to claim 16 wherein the biological material comprises a biopolymer; the molecular-scale, nanoscale, microscale or mesoscale form, morphology, texture, or topography of the substrate has been reproduced in a mold of the biopolymer comprising silicon compounds; and the biopolymer has been removed to leave only the mold.

18. The composition of matter according to claim 17 wherein the mold is a support for catalytic materials.

19. The composition of matter forming a mold of a biological template substrate, comprising:
silica, silicates, silicic acids, or polysilicic acid, and mixtures thereof;
in which the microscale or nanoscale form, morphology, texture, or topography of the biological template substrate has been replicated.

20. The composition of matter according to claim 19 wherein the biological template substrate has been removed to leave only a mold of the biological template substrate and wherein the mold is comprised of silica.

21. The composition of matter according to claim 19 wherein the biological template substrate is a biopolymer.

22. The composition of matter of claim 20 wherein the mold of the biological template substrate has a density approximately equal to the density of an aerogel.

23. The composition of matter of claim 21 wherein the mold of the biopolymer has a density in the range of from about 0.002 g/mL to about 0.10 g/mL.

24. The composition of matter of claim 21 made by the method of claim 6.

25. The composition of matter of claim 19 characterized by mechanical stability and replication of molecular-scale surface detail of the biological template substrate.
